(19) United States
(12) Patent Application Publication
(10) Pub. No.: US 2013/0318609 A1
(43) Pub. Date: Nov. 28, 2013

(54) METHOD AND APPARATUS FOR QUANTIFYING THREAT SITUATIONS TO RECOGNIZE NETWORK THREAT IN ADVANCE

(71) Applicant: Electronics and Telecommunications Research Institute, Daejeon (KR)

(72) Inventors: Ki Young KIM, Daejeon (KR); Sungwon YI, Daejeon (KR); Sun Hee LIM, Daejeon (KR); Jonghyun KIM, Daejeon (KR); Dae-Hee SEO, Daejeon (KR); BYUNG-GIL LEE, Daejeon (KR)

(73) Assignee: Electronics and Telecommunications Research Institute, Daejeon (KR)

(21) Appl. No.: 13/902,069

(22) Filed: May 24, 2013

(30) Foreign Application Priority Data
May 25, 2012 (KR) 10-2012-0056079
Mar. 4, 2013 (KR) 10-2013-0022675

(51) Int. Cl. H04L 29/06

(52) U.S. Cl. CPC H04L 63/1441
USPC 726/23

(57) ABSTRACT

An apparatus for quantifying network threat situations includes a traffic analyzing unit to analyze packet patterns of traffics occurring on a target network being monitored to extract one or more suspicious domains. An IP monitoring unit gives security levels among a plurality of security levels to the suspicious domains according to the number of access IPs accessing the suspicious domains. An activity index computing unit computes activity indices for the suspicious domains from activity indices according to the access times to the suspicious domains of the access IPs. An attack amount anticipation unit analogizes an expected amount of attacks for each suspicious domain according to an expected amount of attacks for each zombie computer, the security level and the activity index of the suspicious domain.

### RELATED APPLICATIONS

This application claims the benefit of Korean Patent Application Nos. 10-2012-0056079, filed on May 25, 2012 and 10-2013-0022675, filed on Mar. 4, 2013, which are hereby incorporated by reference as if fully set forth herein.

### FIELD OF THE INVENTION

The present invention relates to a method and apparatus for quantifying network threat situations. More particularly, the present invention relates to a method and apparatus for quantifying and analogizing an expected amount of network attacks to recognize network threats in advance.

### BACKGROUND OF THE INVENTION

In a conventional technique for quantifying network threats, a massive network attack on a target network such as a distributed denial of service attack has been made before threat situations on the network were classified into risk level on the basis of security event log information. Otherwise, the threat situations are quantified based on a traffic volume and then risk levels are computed.

However, it is not clear whether changes in such security event log information and traffic volume can lead to an actual attack, so that there are problems in using such changes to anticipate the future.

Further, an attack begins to shut a server down and a target network under attack becomes inaccessible before the security event log information is used to compute the scale of attack traffics, which may be referred to issuance of warning to report the current security situation.

Accordingly, such conventional technique has a problem incapable of recognizing the network threat situations in advance.

### SUMMARY OF THE INVENTION

In view of the above, the present invention provides a method and apparatus for recognizing network threat situations in advance by analogizing an expected amount of network attacks according to the monitoring result of suspicious domains and accessed IPs extracted by analyzing traffic patterns occurring in a network under monitoring.

The present invention will not be limited to the above, and another object, which has not been described, will be clearly understood to those skilled in the art from the following description.

In accordance with an exemplary embodiment of the present invention, there is provided a method for quantifying network threat situations, which includes: analyzing packet pattern of DNS (Domain Name Server) traffics occurring on a target network being monitored to extract one or more suspicious domains; giving security levels among a plurality of different security levels to the suspicious domains according to a monitoring result of access IPs with which the suspicious domains are accessed; computing activity indices for the suspicious domains among different activity indices according to a monitoring result of access to the suspicious domains taken by the access IPs; and analogizing an expected amount of attacks for each suspicious domain according to an expected amount of attacks for each zombie computer, the security level and the activity index of the suspicious domain.

In the embodiment, analyzing packet patterns of traffics includes analyzing packet patterns of query traffic or answer traffic between client computers on the target network and a DNS server.

In the embodiment, giving security levels includes differently assigning the security levels to the suspicious domains depending on the number of the access IPs.

In the embodiment, computing activity indices for the suspicious domains includes differently assigning the activity indices to the suspicious domains depending on access times of the suspicious domains.

In the embodiment, analogizing an expected amount of attacks for each suspicious domain includes analogizing the expected amount of attacks for each suspicious domain using the minimum amount of a distributed denial of service attacks for each zombie computer or the maximum amount of the distributed denial of service attacks for each zombie computer.

In the embodiment, the expected amount of attacks for each suspicious domain includes a value between the minimum expected amount of attacks calculated using the minimum amount of the distributed denial of service attacks for each zombie computer and the maximum expected amount of attacks calculated using the maximum amount of the distributed denial of service attacks for each zombie computer.

In accordance with another exemplary embodiment, there is provided an apparatus for quantifying network threat situations, which includes: a traffic analyzing unit configured to analyze packet patterns of traffics occurring on a target network being monitored to extract one or more suspicious domains; an IP monitoring unit configured to give security levels among a plurality of different security levels to the suspicious domains according to a monitoring result of access IPs with which the suspicious domains are accessed; an activity index computing unit configured to compute activity indices for the suspicious domains from different activity indices according to a monitoring result of access to the suspicious domains taken by the access IPs; and an attack amount anticipation unit configured to analogize an expected amount of attacks for each suspicious domain according to an expected amount of attacks for each zombie computer, the security level and the activity index of the suspicious domain.

In the embodiment, the traffic analyzing unit analyzes the packet patterns of query traffic or answer traffic between client computers on the target network and a DNS server.

In the embodiment, the IP monitoring unit differently assigns the security levels to the suspicious domains depending on the number of the access IPs.

In the embodiment, the activity index computing unit differently assigns the activity indices to the suspicious domains depending on access times to the suspicious domains.

In the embodiment, the attack amount expectation unit analogizes the expected amount of attacks for each suspicious domain using the minimum amount of the distributed denial of service attacks for each zombie computer or the maximum amount of the distributed denial of service attacks for each zombie computer.

In the embodiment, the expected amount of attacks for each suspicious domain includes a value between the minimum expected amount of attacks calculated using the minimum amount of the distributed denial of service attacks for each zombie computer and the maximum expected amount of attacks calculated using the maximum amount of the distributed denial of service attacks for each zombie computer.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of an apparatus for quantifying network threat situations in accordance with an exemplary embodiment of the present invention; and

FIG. 2 is a flow chart illustrating a method for quantifying network threat situations performed by the apparatus shown in FIG. 1 in accordance with an exemplary embodiment of the present invention.

### DETAILED DESCRIPTION OF THE EMBODIMENTS

The advantages and features of embodiments and methods of accomplishing the present invention will be clearly understood from the following described description of the embodiments taken in conjunction with the accompanying drawings. However, the present invention is not limited to those embodiments and may be implemented in various forms. It should be noted that the embodiments are provided to make a full disclosure and also to allow those skilled in the art to know the full range of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereinafter, embodiments of the present invention will be described in detail with reference to the accompanying drawings which form a part hereof.

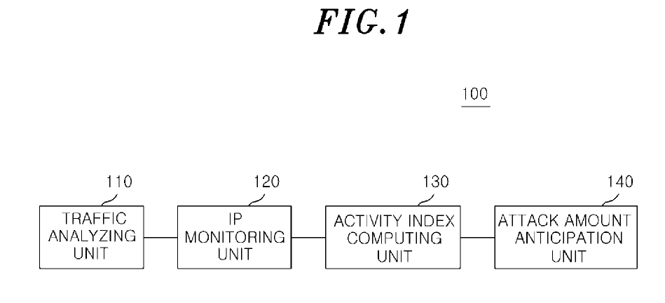

FIG. 1 is a block diagram of an apparatus for quantifying network threat situations in accordance with an exemplary embodiment of the present invention.

As illustrated in FIG. 1, an apparatus 100 for quantifying network threat situations includes a traffic analyzing unit 110, an IP monitoring unit 120, an activity index computing unit 130, and an attack anticipation unit 140.

The traffic analyzing unit 110 analyzes packet patterns of DNS (Domain Name Server) traffics occurring on a target network being monitored to extract one or more suspicious domains. To be more specific, the traffic analyzing unit 110 analyzes the packet patterns of any one or two traffics of query traffic and answer traffic between client computers on the target network and a DNS server, thereby extracting one or more suspicious domains.

The IP monitoring unit 120 gives ones of a plurality of different security levels to the suspicious domains according to a monitoring result of access IPs, which access the suspicious domains. For example, the IP monitoring unit 120 differently assigns the security levels to the respective suspicious domains depending on the number of the access IPs.

The activity index computing unit 130 allocates activity indices for the suspicious domains among different activity indices according to the monitoring result of access to the suspicious domains made by the access IPs. For example, the activity index computing unit 130 differently assigns the activity levels for the suspicious domains depending on access times to the suspicious domains.

The attack amount anticipation unit 140 analogizes the expected amount of attacks for each suspicious domain according to the expected amount of attacks for each zombie computer and a security level and an activity index. In other words, the attack amount anticipation unit 140 analogizes the expected amount of attacks for each suspicious domain using the minimum amount of a distributed denial of service attacks for each zombie computer or the maximum amount of the distributed denial of service attacks for each zombie computer. For example, the expected amount of attack for each suspicious domain may be a value between the minimum expected amount of attack calculated using the minimum amount of the distributed denial of service attacks for each zombie computer and the maximum expected amount of attacks calculated using the maximum amount of the distributed denial of service attacks for each zombie computer.

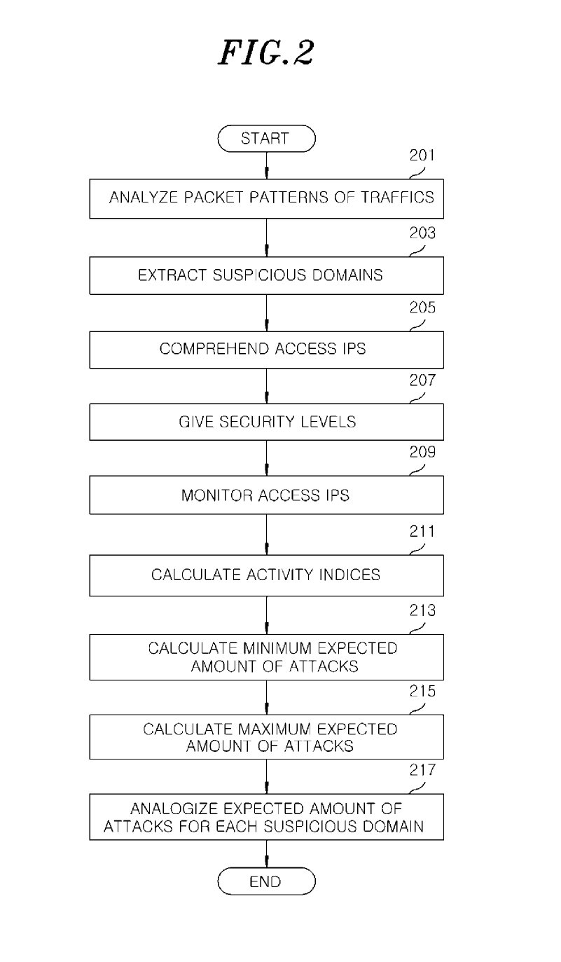

FIG. 2 is a flow chart illustrating a method for quantifying network threat situations performed by the apparatus shown in FIG. 1 in accordance with an exemplary embodiment of the present invention.

As illustrated in FIG. 2, a method for quantifying network threat situations includes the operations of: analyzing packet patterns of traffics occurring in a target network being monitored in operation 201 and extracting one or more suspicious domains in operation 203; monitoring access IPs which access the suspicious domains in operations 205 and giving security levels among a plurality of different security levels to the suspicious domains according to the monitoring result in operation 207; inspecting access to the suspicious domains taken by the access IPs in operation 209 and computing activity indices for the suspicious domains among different activity indices according to the access number to the suspicious domain in operation 211; analogizing the expected amount of attacks for each suspicious domain using the minimum amount of the distributed denial of service attacks for each zombie computer in operation 213; analogizing the expected amount of attacks for each suspicious domain using the maximum amount of the distributed denial of service attacks for each zombie computer in operation 215; and analogizing the expected amount of attacks for each suspicious domain as a value between the minimum expected amount of attacks for each zombie computer and the maximum expected amount of attacks for each zombie computer in operation 217.

Hereinafter, a procedure for quantifying network threat situations will be described in detail with reference to FIGS. 1 and 2.

First, in operation 201, the traffic analyzing unit 110 analyzes packet patterns of any one or two traffics of query traffic and answer traffic between client computers and a DNS server, which occur in a target network being monitored. In operation 203, the traffic analyzing unit 110 estimates one or more domains having abnormal patterns as C&C (Command & Control) servers and extracts the one or more domains as suspicious domains in operation 203. Further, the IP monitoring unit 120 comprehends and monitors access IPs which accesses the suspicious domains on the basis of log information of the suspicious domains extracted by the traffic analyzing unit 110 in operation 205.

In this case, monitoring the access IPs is performed via an access point of the International Gateway Office or the International Interworking section, as similar as a common technology for searching C&C servers, thereby enhancing precision.

The IP monitoring unit 120 gives a security level among a plurality of different security levels to each of the suspicious domains according to the number of the access IPs on the basis of the monitoring result of the access IPs with which the suspicious domains are accessed in operation 207.

In other words, the IP monitoring unit 120 collects log information about the suspicious domains and the access IPs that try to access the IPs of the suspicious domains with respect to a DNS service for the target network, for example, access type and access log information on the client computers and analyzes an association between them. Further, the IP monitoring unit 120 gives the security levels differently to the suspicious domains depending on the number of access IPs with which the suspicious domains are accessed, that is, the scale of a botnet.

For example, a first security level may be assigned when the number of accumulated attacks a day is 0 to 200, a second security level assigned for 201 to 400 attacks, a third security level assigned for 401 to 600 attacks, a fourth security level assigned for 601 to 800 attacks, and a fifth security level assigned for 801 attacks or more. It means that the security levels are risk levels whose risk is proportional to the number of access IPs with which the suspicious domains are accessed, that is, the number of accumulated attacks. Such security levels may be changed in consideration of a method of quantizing network threat situations while operating the method continuously.

Next, the activity index computing unit 130 inspects the access to the suspicious domains via the access IPs comprehended by the IP monitoring unit 120 in operation 209, and differently allocates the activity indices for the suspicious domains depending on the access times to the suspicious domains in accordance with the inspection result in operation 211.

For example, the activity index computing unit 130 monitors the access times and access types to the suspicious domains, which has been performed by the client computers having the access IPs, divides the access times by 5 sections, and sequentially set values of 0.2, 0.4, 0.6, 0.8 and 1 to the activity indices while moving from a section having low access times to a section having high access times. Such activity index may be changed in consideration of the result of a method for quantifying network threat situations while operating the method continuously.

Next, the attack amount anticipation unit 140 calculates the minimum expected amount of attacks for each suspicious domain according to the minimum amount of the distributed denial of service attacks for each zombie computer, a security level and an activity index in operation 213.

For example, the minimum expected amount of attacks for each suspicious domain may be calculated by multiplying a predefined minimum amount of the distributed denial of service attacks for each zombie computer by the security level and the activity index of the corresponding suspicious domain.

Thereafter, the attack amount anticipation unit 140 calculates the maximum expected amount of attacks for each suspicious domain according to the maximum amount of the distributed denial of service attacks for each zombie computer, the security level and the activity index in operation 215.

For example, the maximum expected amount of attacks for each suspicious domain may be calculated by multiplying a predefined maximum amount of the distributed denial of service attacks for each zombie computer known by the security level and the activity index.

When performing the multiplication at the operations 213 and 215, the value of the security level may be replaced by the number of the access IPs obtained at the operation 205. Otherwise, it may be replaced by a section value of the corresponding security level. For example, in case of a first security level, a section value of the first security level may be 100, which corresponds to the median value of 0 to 200 attacks, and may be replaced with the value of the security level in the multiplication.

Next, the attack amount anticipation unit 140 analogizes an expected amount of attacks for each suspicious domain as a value between the minimum expected amount of attacks for each suspicious domain calculated at operation 213 and the maximum expected amount of attacks for each suspicious domain in operation 217. For example, an expected amount of attacks for each suspicious domain may be analogized as an average value of the minimum expected amount of attacks for each suspicious domain and the maximum expected amount of attacks for each suspicious domain.

Subsequently, the attack amount anticipation unit 140 may externally output or display the expected amount of attacks for each analogized suspicious domain through an interface. When a control center is informed such expected amount of attacks for each suspicious domain, the control center issues a warning about an attack sign occurring at the entire network level in order that network threats can be recognized in advance.

As described above, it is possible to recognize network threat situations in advance by analogizing an expected amount of network attacks based on the monitoring result of suspicious domains and accessed IPs extracted by analyzing the DNS traffic patterns occurring in a network under monitoring.

Further, it is possible to prevent attacks in advance, forecast threat situation or make issuance of warning on the basis of information on suspicious domains and an expected amount of attack.

The combinations of the each block of the block diagram and each step of the flow chart may be performed by computer program instructions. Because the computer program instructions may be loaded on a general purpose computer, a special purpose computer, or other processor of programmable data processing equipment, the instructions performed through the computer or other processor of programmable data processing equipment may generate the means performing functions described in the each block of the block diagram and each step of the flow chart. Because the computer program instructions may be stored in the computer available memory or computer readable memory which is capable of intending to a computer or other programmable data processing equipment in order to embody a function in a specific way, the instructions stored in the computer available memory or computer readable may produce a manufactured item involving the instruction means performing functions described in the each block of the block diagram and each step of the flow chart. Because the computer program instructions may be loaded on the computer or other programmable data processing equipment, the instructions performing the computer or programmable data processing equipment may provide the steps to execute the functions described in the each block of the block diagram and each step of the flow chart by a series of operational steps being performed on the computer or programmable data processing equipment, thereby a process executed by a computer being generated.

Moreover, the respective blocks or the respective sequences may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A method for quantifying network threat situations, the method comprising:
analyzing packet pattern of DNS (Domain Name Server) traffics occurring on a target network being monitored to extract one or more suspicious domains;
giving security levels among a plurality of different security levels to the suspicious domains according to a monitoring result of access IPs with which the suspicious domains are accessed;
computing activity indices for the suspicious domains among different activity indices according to a monitoring result of access to the suspicious domains taken by the access IPs; and
analogizing an expected amount of attacks for each suspicious domain in accordance with an expected amount of attacks for each zombie computer, the security level and the activity index of the suspicious domain.

2. The method of claim 1, wherein said analyzing packet patterns of traffics comprises analyzing packet patterns of query traffic or answer traffic between client computers on the target network and a DNS server.

3. The method of claim 1, wherein said giving security levels comprises differently assigning the security levels to the suspicious domains depending on the number of the access IPs.

4. The method of claim 1, wherein said computing activity indices for the suspicious domains comprises differently assigning the activity indices to the suspicious domains depending on access times of the suspicious domains.

5. The method of claim 1, wherein said analogizing an expected amount of attacks for each suspicious domain comprises analogizing the expected amount of attacks for each suspicious domain using the minimum amount of a distributed denial of service attacks for each zombie computer or the maximum amount of a distributed denial of service attacks for each zombie computer.

6. The method of claim 5, wherein the expected amount of attacks for each suspicious domain comprises a value between the minimum expected amount of attacks calculated using the minimum amount of a distributed denial of service attacks for each zombie computer and the maximum expected amount of attacks calculated using the maximum amount of a distributed denial of service attacks for each zombie computer.

7. An apparatus for quantifying network threat situations, the apparatus comprising:
a traffic analyzing unit configured to analyze packet patterns of DNS (Domain Name Server) traffics occurring on a target network being monitored to extract one or more suspicious domains;
an IP monitoring unit configured to give security levels among a plurality of different security levels to the suspicious domains according to a monitoring result of access IPs with which the suspicious domains are accessed;
an activity index computing unit configured to compute activity indices for the suspicious domains from different activity indices according to a monitoring result of access to the suspicious domains taken by the access IPs; and
an attack amount anticipation unit configured to analogize an expected amount of attacks for each suspicious domain according to an expected amount of attacks for each zombie computer, the security level and the activity index of the suspicious domain.

8. The apparatus of claim 7, wherein the traffic analyzing unit analyzes the packet patterns of query traffic or answer traffic between client computers on the target network and a DNS server.

9. The apparatus of claim 7, wherein the IP monitoring unit differently assigns the security levels to the suspicious domains depending on the number of the access IPs.

10. The apparatus of claim 7, wherein the activity index computing unit differently assigns the activity indices to the suspicious domains depending on access times to the suspicious domains.

11. The apparatus of claim 7, wherein the attack amount expectation unit analogizes the expected amount of attacks for each suspicious domain using the minimum amount of a distributed denial of service attacks for each zombie computer or the maximum amount of a distributed denial of service attacks for each zombie computer.

12. The apparatus of claim 11, wherein the expected amount of attacks for each suspicious domain comprises a value between the minimum expected amount of attacks calculated using the minimum amount of a distributed denial of service attacks for each zombie computer and the maximum expected amount of attacks calculated using the maximum amount of a distributed denial of service attacks for each zombie computer.
